(19) United States
(12) Patent Application Publication
(10) Pub. No.: US 2023/0330910 A1
(43) Pub. Date: Oct. 19, 2023

(54) METHOD FOR MANUFACTURING AN INJECTION-MOULDED ARTICLE USING A RECYCLED POLYESTER

(71) Applicant: L'OREAL, Paris (FR)

(72) Inventors: Jean-Marie HERVET, Clichy (FR); Ines DE SANDERVAL, Chevilly La Rue (FR); Olivier FARNAULT, Aulnay-Sous-Bois (FR)

(73) Assignee: L'OREAL, Paris (FR)

(21) Appl. No.: 17/759,643

(22) PCT Filed: Jan. 27, 2021
(86) PCT No.: PCT/EP2021/051883

§ 371 Date: Jul. 28, 2022

(30) Foreign Application Priority Data
Jan. 29, 2020 (FR) FR2000881

(51) Int. Cl. B29C 49/00; B29C 49/06

(52) U.S. Cl. CPC B29C 49/0005; B29C 49/06; B29C 49/10

(57) ABSTRACT

Method for manufacturing an injection-moulded article using a recycled polyester Method for manufacturing an injection-moulded article, preferably a preform (11) of a bottle (I) in particular an aerosol bottle, made of polyester, said article, in particular said preform (II), preferably comprising a tubular body (14) closed at one end (16), the method comprising the following steps of: a) providing at least one polymer material comprising a recycled polyester in a weight proportion of at least 10% relative to the total weight of said at least one polymer material and an eventually supplement comprising virgin polyester to form the 100% by weight of said at least one polymer material, b) producing the injection-moulded article by injecting, into a mould, said at least one polymer material.

### TECHNICAL FIELD

The present invention relates to the manufacture of injection-moulded articles and also of finished and semifinished products, in particular aerosol bottles, that is to say pressurized bottles intended to receive a composition and a propellant gas, in particular a liquefied propellant gas.

### PRIOR ART

It has been proposed to produce aerosol bottles from thermoplastic material. To this end, a preform is produced by injection-moulding a thermoplastic polymer material, for example PET, with a neck intended for the fastening of a dispensing head. In order to improve the mechanical strength of the neck, the plastic material is subjected to a crystallizing heat treatment in the region of said neck. Next, the preform is transferred to a blow-moulding station in order to give the body of the bottle its final shape. While reinforcing the mechanical strength, crystallization makes the bottle lighter.

A plastic aerosol bottle should comply with regulations. Tests on a plastic aerosol bottle containing a liquefied gas are generally more difficult to satisfy than those relating to plastic aerosol bottles containing a compressed gas.

The tests make it possible to verify that the plastic pressurized bottle is able to resist an operating pressure of generally several bar on account of the presence of a pressurized gas, notably a pressurized liquefied gas, inside it. This resistance has to be verified at a relatively high temperature in order to ensure safety in use. Furthermore, since the bottle can be filled under vacuum, this ensures squeeze resistance when the reduced pressure is at a maximum, before filling is started. The bottle also has to be resistant to impacts, notably to being dropped at different temperatures.

Within the context of reducing the environmental impact, it is sought to introduce a recycled polymer material into the constituent material of the bottle.

However, many tests performed have shown that not all recycled thermoplastic polymers were suitable and, in particular, did not successfully undergo the regulatory tests.

EP2763908 discloses a plastic bottle for containing perfume compositions and having improved crazing resistance. The plastic bottle comprises poly(ethylene-2,5-furandicarboxylate) (PEF).

WO 02/20246 describes a method and an apparatus for making articles made of polyester, having coated directly to at least one of the surfaces thereof one or more layers of recycled or post-consumer PET and one or more layers of a material with good gas-barrier characteristics, preferably silicon oxide.

JP2005193575 presents a method for producing a bottle by injection moulding with a resin containing a recycled polyethylene terephthalate as main component. The heating temperature of the injection moulding, the injection time, and the cooling time are set in a specified range corresponding to a measured kinetic viscosity of the resin.

EP 1 547 768 discloses an article produced by injection-moulding having an inner layer of a thermoplastic material comprising a recycled polyethylene terephthalate.

US 2019/225355 describes an aerosol container made of plastic. The main plastic can comprise a recycled polyethylene terephthalate.

US 2012/211458 presents an aerosol container comprising a main body portion that is constructed and arranged to withstand aerosol pressurization within a range that is about 90-180 psi and a threaded finish portion that is unitary with the main body portion.

There is a need to benefit from a method for manufacturing an injection-moulded article, in particular an aerosol bottle preform, containing a recycled polymer in the constituent material of the injection-moulded article, in particular intended for the manufacture of a finished or semifinished product such as an aerosol bottle, while maintaining positive results in the finished or semifinished product tests.

### SUMMARY OF THE INVENTION

Method for Manufacturing an Injection-Moulded Article

The present invention aims to resolve all or part of this need and it achieves this by virtue of a method for manufacturing an injection-moulded article, preferably a preform of an aerosol bottle, made of polyester, in particular made of polyethylene terephthalate, said article, in particular said preform, preferably comprising a tubular body closed at one end, the method comprising the following steps:
a) providing at least one polymer material comprising a recycled polyester, in particular a recycled polyethylene terephthalate, in a weight proportion of at least 10% relative to the total weight of said at least one polymer material and an optional supplement comprising virgin polyester, in particular virgin polyethylene terephthalate, to form the 100% by weight of said at least one polymer material,
b) producing the injection-moulded article by injecting, into a mould, said at least one polymer material.

Owing to the invention and the choice of the polyester, in particular polyethylene terephthalate (PET), a method is benefited from that makes it possible to manufacture an injection-moulded article, such as an aerosol bottle preform, which incorporates at least 10% of a recycled material.

A “virgin polyester” or “virgin polymer material” is understood to mean a non-recycled polyester or a non-recycled polymer material.

Preferably, there is a recycled polymer material comprising a polyester, in particular a polyethylene terephthalate, and optionally a virgin polymer material comprising a polyester, in particular a polyethylene terephthalate.

Said at least one polymer material is preferably chosen to be crystallizable, advantageously weakly crystallizable.

The weak crystallizability of the constituent polymer material(s) of the article may make it possible to better control, geographically and dimensionally, the crystallisation of one portion only of the injection-moulded article, for example of a neck of the bottle preform.

Thus, the polymer material(s) chosen are advantageously crystallizable, but preferably not very crystallizable.

The method may comprise the step consisting in crystallizing a portion of the injection-moulded article, in particular a neck.

After this step, the weight-fraction degree of crystallinity, which measures the proportion of material that is in the crystalline state, may be greater than 20% in the crystallized part of the injection-moulded article, for example between 20% and 80%, in particular between 25% and 50%. There may be an intermediate zone of the injection-moulded article with a weight-fraction degree of crystallinity for example of between 8% and 20% in the immediate vicinity of the crystallized part and finally a non-crystallized or only slightly crystallized zone with a weight-fraction degree of crystallinity of less than 8% for example.

The weight-fraction degree of crystallinity may be measured by x-ray diffraction, or using spectrometry methods such as infrared spectrophotometry, or else using a differential scanning calorimeter (DSC) or by microscopy.

The intrinsic viscosity of the recycled polyester, in particular of the recycled polyethylene terephthalate, is preferably greater than or equal to 0.8 dl/g. The intrinsic viscosity of the virgin polyester, in particular of the virgin polyethylene terephthalate, when present, is preferably greater than or equal to 0.8 dl/g.

The intrinsic viscosity may be measured according to the AFNOR ISO 1628-5 standard by a torque in a flow of molten material. The intrinsic viscosity is a mechanical feature which makes it possible to measure whether the polymer material will withstand the regulatory temperature and pressure constraints. The value greater than or equal to 0.8 dl/g for the intrinsic viscosity of the virgin and/or recycled polyester makes it possible to withstand the regulatory constraints, in terms of safety and pressure.

In one particular embodiment, the recycled polyester, in particular the recycled polyethylene terephthalate, is obtained by mechanical recycling. In this case, the amount by weight of the recycled polyester, in particular of the recycled polyethylene terephthalate, in said at least one polymer material is preferably between 10% and 90%, the amount by weight of the virgin polyester, in particular of the virgin polyethylene terephthalate, in particular being at least 10% relative to the total weight of said at least one polymer material.

In another embodiment, said at least one recycled polymer material is obtained by chemical recycling.

In another embodiment, said at least one recycled polymer material is obtained by enzymatic recycling.

In another embodiment, said at least one recycled polymer material is obtained by pyrolysis recycling.

In another embodiment, use is made of at least two recycled polymer materials obtained by at least two different recycling methods chosen from mechanical recycling, chemical recycling, enzymatic recycling and pyrolysis recycling. That means, in this case, that it is possible to have a recycled polymer material which is obtained by mechanical recycling, for example, and another recycled polymer material obtained by chemical recycling for example.

When said at least one recycled polymer material is obtained by chemical, enzymatic or pyrolysis recycling, the amount by weight of the recycled polyester, in particular of the recycled polyethylene terephthalate, in the polymer material may be between 10% and 100%.

In this case, it is possible to manufacture an injection-moulded article with 100% of recycled polyester, in particular of recycled polyethylene terephthalate. In that case, said at least one polymer material comprises 100% of recycled polyester. Specifically, these recycling methods make it possible to have a quality and properties of recycled polyester, in particular of recycled polyethylene terephthalate, which are the same as the same virgin polyester, in particular the same virgin polyethylene terephthalate. When said at least one recycled polymer material is obtained by chemical, enzymatic or pyrolysis recycling, the recycled polymer material is identical to the virgin polymer material, since these recycling methods make it possible to return to the base monomer.

As a variant, the amount by weight of recycled polyester, in particular of recycled polyethylene terephthalate, in the polymer material may be strictly less than 100%, said at least one polymer material consisting of a mixture of recycled polyester, in particular of recycled polyethylene terephthalate and of virgin polyester, in particular of virgin polyethylene terephthalate.

The recycled polyester preferably comprises less than 20 ppm of particles other than polyester. This makes it possible to have a polyester of sufficient quality so as not to significantly impair the properties of said at least one polymer material and makes it possible to obtain an article with good mechanical properties. Certain types of recycling, in particular chemical, enzymatic or pyrolytic recycling, make it possible to limit the number of particles other than virgin or recycled polyester.

The injection-moulded article is preferably devoid of compatibilizing agent between the recycled polyester and the virgin polyester. Advantageously, there is no other polyethylene terephthalate, polybutylene terephthalate or thermoplastic polyester than the recycled polyester and the virgin polyester if present. In particular, there is no addition of compatibilizing agent, notably of polymer or of copolymer making the polymers compatible with one another.

The polyester may be chosen from the group constituted by filled or unfilled polyethylene terephthalates, filled or unfilled polybutylene terephthalates (PBTs) and filled or unfilled polyethylene naphtalates (PENs). The polyester is advantageously a polyethylene terephthalate (PET). When it takes place, the crystallization step is advantageously carried out with the aid of a heating device, in particular a heating device having an infrared radiation lamp.

The heating device is preferably adjusted so as to apply a temperature gradient for obtaining the desired degrees of crystallinity. The heating temperature may be nonuniform. The distance between the heating device and the preform may be adjusted to this effect.

The heating device is preferably arranged in such a way as to prevent crystallization of the tubular body of the injection-moulded article, which will be heated later and then subjected to the blowing operation.

At least one cooling bar may be brought in close to the preform from the inside or outside thereof, simultaneously with the heating. In a variant or additionally, it may be introduced into the preform simultaneously with the heating, notably via the opening in the neck of the preform. Such a cooling bar serves to cool the zone that is not intended to be crystallized and also to achieve a gradient between the heated zone, where the maximum degree of crystallinity is obtained, and the unheated zone, where the degree of crystallinity is at a minimum. Another cooling system, different than a cooling bar, may be provided for the same purpose without departing from the scope of the invention.

When a crystallization step is provided, the injection-moulded article, in particular the injection-moulded preform, may be held for a sufficient duration under storage conditions such that it undergoes moisture absorption of at least 0.4%, better still at least 0.8%, and even better still at least 1%, by weight, the absorption being preferably less than 3% by weight. The presence of moisture can in particular make it easier to obtain a desired crystallinity gradient within the crystallized part, in particular the neck.

The article is preferably an aerosol bottle preform, comprising a tubular body closed at one end and a neck.

In this case, and in the case where the crystallization step takes place, the crystallized part is the neck of the preform.

The bottle is advantageously an aerosol bottle, also referred to as a pressurized bottle. The bottle may be as described in patent application FR 3 047 234, the content of which is incorporated herein by way of reference.

In step b, the injection-moulded article may be produced by injecting, into a mould, said at least one polymer material and at least one additive. The at least one additive may be chosen in the group consisting of dyes, UV-blockers, masterbatch, stabilisation additives, foreign polymers or mixture thereof. The weight proportion of the at least one additive in the injection-moulded article may be up to 10%.

By “masterbatch” we mean a solid additive for polymers used for coloring polymers (color masterbatch) or imparting other properties to polymers (additive masterbatch).

Method for Manufacturing a Bottle

A further subject of the invention is, according to another of its aspects, a method for manufacturing a bottle, in particular an aerosol bottle, in which the bottle is formed by stretch-blow-moulding the preform obtained by the method as defined above.

Preform

A further subject of the invention is, according to another of its aspects, an injection-moulded article, in particular a preform, obtained using the method for manufacturing an injection-moulded article, in particular a preform, as defined above, said article, in particular said preform, preferably comprising a tubular body closed at one end.

Bottle

A further subject of the invention is, according to another of its aspects, a bottle, in particular an aerosol bottle, obtained from a preform obtained using the method for manufacturing an injection-moulded article, in particular a preform, as defined above. The bottle is also obtained using the process for manufacturing a bottle as defined above.

The bottle may contain a cosmetic product or the like.

The bottle may contain a liquefied or compressed gas, with an overpressure of between 1 and 13 bar (10⁵ and 13×10⁵ Pa) at 20° C.

The bottle may have a dispensing system for dispensing the cosmetic product contained therein, provided with an actuating member that the user can press in order to dispense the product through at least one outlet orifice, for example in the form of a spray, a foam, a gel or a cream. The dispensing system has for example a push button and a cup, fastened to the container, bearing a valve with a hollow control stem to be controlled by being depressed or tilted.

The bottle may also have a system of the Bag-on-Valve (BoV) type, having an aerosol valve with a welded bag. In this case, the composition is placed inside the bag while the propellant fills the space around the bag inside the bottle. The composition is dispensed by the propellant by simply pressing the bag. When the actuating member is depressed, the composition is extracted from the bag by the pressure of the propellant, this causing the composition to be dispensed in particular in the form of a spray, cream or gel.

The bottle also advantageously comprises a container comprising a body obtained by stretch-blow-moulding the tubular body of the preform and also a neck, which is the neck of the preform, and which is preferably crystallized. The body of the bottle preferably has a portion with a substantially frustoconical shape, better still a frustoconical shape with a rectilinear generatrix, which extends over at least one third of the total height of the container, or even over more than half, or even over more than two thirds of the container.

The bottle preferably comprises a minimum amount of material associated with the thickness of the container in certain areas, so as to nevertheless successfully undergo the mechanical strength tests. For example, the container may have a minimum thickness of 0.65 mm, notably of between 0.65 mm and 1.13 mm, in an area with a height of at least 6 mm that is situated, starting from the upper end of the neck, at a distance of between 10% and 40% of the total height of the container. The container preferably has, at a lower end of the body, a thickness of at least 1.1 mm, in particular between 1.1 and 2 mm.

### BRIEF DESCRIPTION OF THE DRAWINGS

The invention may be better understood upon reading the following detailed description of non-limiting implementation examples thereof, and upon examining the appended drawing, in which:

FIG. 1 schematically shows an example of an aerosol bottle according to the invention,

FIG. 2 schematically shows the preform on its own,

FIG. 3 shows the body of the bottle after the blow-moulding of the preform, on its own,

FIG. 4 is a block diagram of a manufacturing method according to the invention,

FIG. 5 is a schematic view in partial section of the preform,

FIG. 6 is a photograph of an example of a bottle according to the invention obtained using the manufacturing method according to the invention,

FIG. 7 is a photograph of the bottle from FIG. 6 after a test at 75° C., and

FIG. 8 is a photograph of the bottle from FIG. 6 after a pressure test, and

FIG. 9 is a diagram illustrating an example of a pressure test.

### DETAILED DESCRIPTION

In the rest of the description, elements that are identical or have identical functions bear the same reference sign. In order to make the present description concise, they are not described for each of the figures, only the differences between the embodiments being described.

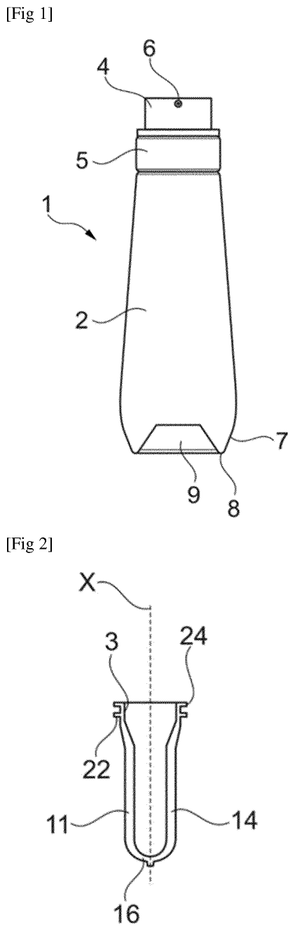

FIG. 1 shows an example of an aerosol bottle 1 produced by implementing the method according to the invention.

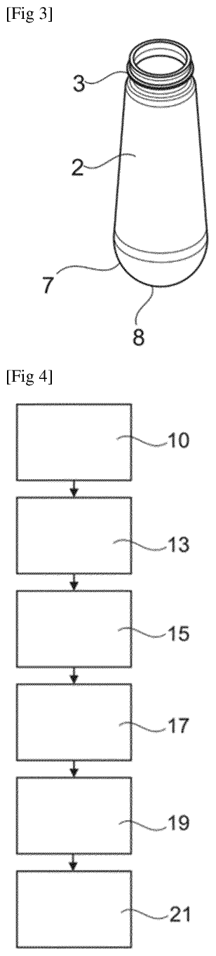

This aerosol bottle 1 has a body 2 made of thermoplastic material, shown on its own in FIG. 3, having a neck 3 on which there is mounted a dispensing head 5 having a push button 4 equipped with a dispensing nozzle 6 and which the user can press to cause the contents of the bottle to be dispensed.

The dispensing head 5 has a cup bearing a valve, which can be fastened to the neck 3 by snap-fastening, crimping or any other means, and have a dip tube (not visible) extending down to the bottom of the bottle.

In the example in question, the bottle contains a composition to be dispensed, for example a cosmetic composition, and a liquefied propellant gas, for example butane.

The body is made in this example from a mixture of recycled polyester, in this example recycled PET, obtained by mechanical recycling, and virgin polyester, in this example virgin PET, in respective weight proportions of 10%/90%. It is not a departure from the scope of the invention if the recycled polyester, in particular the recycled PET, is obtained by chemical, enzymatic or pyrolysis recycling. No compatiblizing agent is added in this example.

The recycled and virgin PETs used in this example have the distinctive feature of having an intrinsic viscosity level of greater than 0.8 dl/g. Their melting point is in particular between 240° C. and 320° C. Their crystallizability is relatively low. Their degree of crystallinity is in this example greater than 30%.

The recycled PET comprises particles other than polyethylene terephthalate in an amount at least equal to 20 ppm.

The neck 3 is at least partially crystallized, while the rest of the body 2 is in an amorphous form. Regarding PET, the amorphous nature causes the material to be transparent, while the crystallization gives it a whitish opacity. The crystallization of the neck 3 makes it possible to improve the mechanical characteristics thereof.

The method, according to the invention, for manufacturing an injection-moulded article, in the example illustrated an aerosol bottle preform, then the body 2 of the aerosol bottle, will now be described with reference to FIG. 4 in particular.

Firstly, in step 10, and in accordance with the invention, two separate hoppers transport the PET, one transporting the recycled PET and the other the virgin PET, so as to form a mixture of recycled and virgin PET polymers indicated above, in the proportions indicated above.

In a step 13, a preform 11, as shown schematically in FIG. 2, is produced by injection-moulding of recycled and virgin PET.

This preform 11 already has the neck 3 with its final shape, and a tubular body 14 closed at one end 16. The neck 3 may have a flange 22 at its base, this being useful for blow-moulding, making it possible to form an end-stop that rests on the blow-moulding mould and is likewise useful for conveying the preform 11 of the body 2 of the bottle, during the preheating of the preform and/or blow-moulding and/or after blow-moulding during the cooling phase. The neck 3 has in its upper part an annular bulge 24 that serves for attaching the dispensing system.

The preform 11 may undergo a moisture absorption step 15 under conditions chosen such that this moisture absorption is at least 0.4% by weight.

Thus, the weight of the preform after moisture absorption is greater by a factor of at least 1.04 than that of the preform before moisture absorption.

In order to obtain the desired moisture absorption, it is possible to store a large number of preforms 11 in a large bag in an air-conditioned store exhibiting a temperature and a humidity that are controlled such that the temperature is between 15 and 25° C. and the relative humidity is at least 30% RH, better still at least 60% RH, even better still at least 80% RH. The storage duration is chosen depending on the storage conditions so as to result in the desired moisture absorption. It is for example at least 7 days, better still at least 15 days. The moisture absorption can also be effected by making use of the natural humidity of the air rather than by using an air-conditioning installation.

Next, the preform 11 is subjected to a crystallizing heat treatment 17 of the neck 3, by exposing the neck 3 of the preform 11 to a heating means employing infrared radiation for example. Examples of heating devices that can be used to effect this heat treatment are described below.

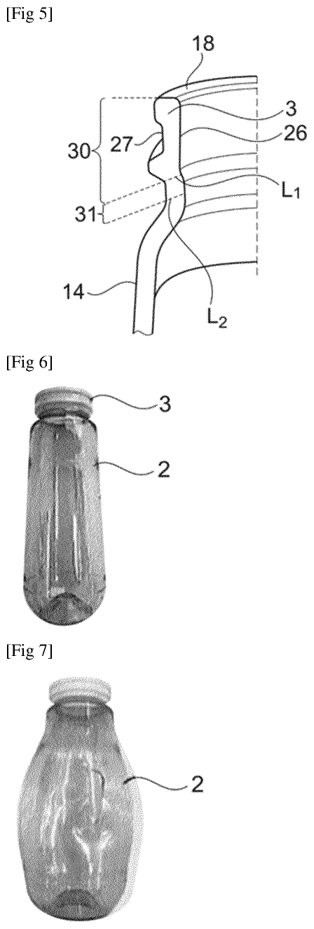

The crystallizing step is preferably implemented in such a way as to obtain, in the neck 3, a first zone 30 and a second zone 31, intermediate between the first zone 30 and the tubular body 14, as illustrated in FIG. 5, having a degree of crystallinity lower than that of the first zone, this second zone extending axially over a height of at least 0.5 mm, and in such a way that the polymer material of the tubular body 14 remains in an amorphous state,

The first zone 20 is located between the upper end 18 of the neck 3 and a lower end at the boundary with the upper end of the second zone 31. This boundary between the first zone 30 and the second zone 31 is embodied, in a virtual manner in FIG. 5, by a line L₁ consisting of a boundary surface between these two zones 30 and 31. The second zone 31 is delimited at the top by this line L₁ and at the bottom by the line L₂, which is a virtual line, consisting of a boundary surface between the second zone 31 and the tubular body 14. Even though it belongs to the neck 3 of the preform 11, the second zone 21 constitutes an intermediate zone between the neck 3 and the tubular body 14. The boundary surfaces L₁ and L₂ are not perpendicular to the longitudinal axis X of the preform 11 but form a conical surface exhibiting a half cone angle equal to approximately 60° with the axis X, as can be seen. The two boundary surfaces have the same angle in this example, but the situation could be otherwise without departing from the scope of the invention.

The second zone 31 has a weight-fraction degree of crystallinity lower than that of the first zone 30, which is preferably nonuniform within the second zone 31. The weight-fraction degree of crystallinity of the tubular body 14 is close to zero, the polymer material being in an amorphous state.

The first zone 30 of the neck is white in colour, the tubular body 14 for its part remaining substantially transparent, whereas the, intermediate, second zone 31 of the neck 3 has a milky appearance, with beige-grey tones, with its visual appearance potentially being nonuniform. The light transmission percentage is higher in the zone of the tubular body 14 than in the second zone 31, which itself has a light transmission percentage that is higher than in the first zone 30, in particular at the wavelength of 973 cm⁻¹. This is connected with the fact that the higher the degree of crystallinity, the lower the light transmission percentage.

The second zone 31 thus forms not only an intermediate zone between the first zone 30 and the tubular body 14 but also a transition zone in terms of degree of crystallinity because the latter is at a maximum in the first zone 30 and at a minimum in the tubular body 14. The presence of this transition zone makes it possible to improve the mechanical properties, in particular the mechanical strength, of the bottle. The bottle produced from the preform 11 may thus be able to withstand the temperature of 75° C.

The degree of crystallinity in the second zone 31 is preferably nonuniform, varying within this zone, either linearly or nonlinearly, in the radial and/or axial direction(s).

In the example illustrated, the degree of crystallinity in the second zone 31, in the axial direction, decreases substantially linearly from the line L₁ towards the line L₂. Similarly, in the example illustrated, the degree of crystallinity in the second zone 21, in the radial direction, decreases substantially linearly from the outer surface 27 towards the inner surface 26.

The flange 22 may be formed on the circumference of the neck 3 in the lower part of the first zone 30, in particular at the lower end of the first zone 30, which in this case may define the boundary with the second zone 31.

The weight-fraction degree of crystallinity of the neck 3 in the first zone 30 is preferably between 20% and 80%, in particular between 25% and 50%, preferably between 25% and 40%, the weight-fraction degree of crystallinity of the neck in the first zone 30 preferably being substantially uniform axially and radially. The degree of crystallinity may be substantially uniform over the entire height of the first zone, which may be between 7 and 11 mm, being for example equal to 9 mm.

The weight-fraction degree of crystallinity in the second zone 31 of the neck 30 is for example between 8% and 20%. The degree of crystallinity preferably exhibits, as indicated above, an axial gradient within the second zone, the degree of crystallinity preferably decreasing from a first end of the second zone in contact with the first zone towards a second end of the second zone in contact with the tubular body. In this case, the degree of crystallinity may vary linearly depending on the position on the longitudinal axis in the second zone, from the first end towards the second end. Alternatively, the degree of crystallinity varies nonlinearly in the axial direction. This second zone forms a crystallization gradient with a height of around 2 mm, in this example.

The degree of crystallinity may exhibit a radial gradient within the second zone, the degree of crystallinity preferably decreasing from an outer surface 27 of the preform towards an inner surface 26 of the preform. In this case, the degree of crystallinity may vary substantially linearly in the second zone in the radial direction between the inner surface of the preform and the outer surface of the preform. Alternatively, the degree of crystallinity varies nonlinearly in the radial direction.

It is the diffusion of heat through the material that governs this variation in the degree of crystallinity within the thickness starting from the highest degree of crystallinity on the outside. The possible presence of water originating from the moisture absorption, if this takes place, within the plastic material of the neck 11 during step 17, improves the thermal conductivity of the neck 3 and the obtaining of the desired crystallization, in a reproducible manner.

The cooling of the preform after heating may be effected using natural convection, that is to say relatively slowly, so as to finalize crystallization.

The cooling duration is for example longer than 30 s, in particular between 30 s and 10 min. The cooling is therefore slow, at ambient temperature.

Once the crystallizing heat treatment has been carried out, the preform is transferred to a stretch-blow-moulding station so as to form, in a stretch-blow-moulding step 19, the body 2 with its final shape, as shown in FIG. 3. The body 2 has for example, as illustrated, a shape that flares downwards as far as a rounded base 7, provided with an indentation 9 on its lower face 8. If necessary, a prior step of heating the preform is carried out before blow-moulding.

Finally, the body of the bottle can be equipped with the dispensing head 5 and filled in a step 21.

### Example

Shown in FIG. 6 in the form of a photograph is an example of a body 2 of an aerosol bottle according to the invention, obtained according to the method of the invention. The volume of the bottle is 140 ml in this example.

This bottle comprises a recycled PET and a virgin PET in respective weight proportions of 25%/75%.

These recycled and virgin PETs both have an intrinsic viscosity level of greater than 0.8 dl/g. Their melting point is between 240° C. and 320° C. Their degree of crystallinity is relatively low, but not zero. There may be crystallites that are detectable by x-ray diffraction for example.

The recycled PET has a content of particles other than polyethylene terephthalate of less than 20 ppm.

After having produced the bottle as indicated above, the body 2 of the bottle illustrated in FIG. 6 is subjected to a temperature test. The result is shown by the photograph in FIG. 7. The body is equipped with the valve. It is a question of placing the bottle at a temperature of 75° C. and of verifying that the valve is not ejected and that it is indeed the body of the bottle that deforms. This is indeed the case here.

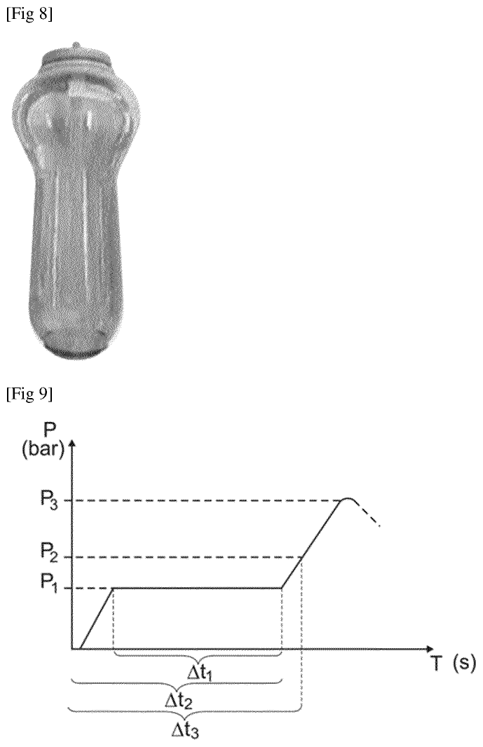

After having produced the bottle as indicated above, the bottle is also subjected to a pressure test, the diagram of which is illustrated in FIG. 9. The result is shown by the photograph in FIG. 8. This test consists in raising the pressure up to a test pressure P₁ that is applied for a period Δt₁=25 s (see the plateau on the diagram of FIG. 9) and in verifying that the deformation is conformal, which is indeed the case here. Also defined, as can be seen in the diagram of FIG. 9, is a required minimum burst pressure P₂ and it is possible to measure the actual burst pressure P₃. There is no visible and permanent deformation during the period Δt₂ which is longer than the period Δt₁ and there is no bursting during the period Δt₃ which is longer than the period Δt₂.

Needless to say, the invention is not limited to the examples that have just been given.

The preform and therefore the bottle may comprise only a recycled polyester and no virgin polyester, in particular in the case of chemical, enzymatic or pyrolysis recycling. Specifically, in this case, the quality of the recycled polyester is sufficient to make it possible not to have virgin polyester in the polymer material.

The crystallization may exhibit other forms than the one described above, for example with nonuniform crystallization about the longitudinal axis of the neck.

The polyester may be other than a polyethylene terephthalate. The polyester may in particular be chosen from the group constituted by filled or unfilled polyethylene terephthalates, filled or unfilled polybutylene terephthalates (PBTs) and filled or unfilled polyethylene naphtalates (PENs).

In step b, the injection-moulded article may be produced by injecting, into a mould, said at least one polymer material and at least one additive. The at least one additive may be chosen in the group consisting of dyes, UV-blockers, masterbatch, stabilisation additives, foreign polymers or mixture thereof. The weight proportion of the at least one additive in the injection-moulded article may be up to 10%.

1. A method for manufacturing an injection-moulded article, made of polyester, the method comprising:
a) providing at least one polymer material comprising a recycled polyester in a weight proportion of at least 10% relative to the total weight of said at least one polymer material and an optional supplement comprising virgin polyester to form the 100% by weight of said at least one polymer material,
b) producing the injection-moulded article by injecting, into a mould, said at least one polymer material.

2. The method according to claim 1, wherein the polymer material is weakly crystallizable, the process comprising crystallizing a portion of the injection-moulded article.

3. The method according to claim 1, wherein the intrinsic viscosity of the recycled polyester is greater than or equal to 0.8 dl/g and the intrinsic viscosity of the optional virgin polyester, when present, is greater than or equal to 0.8 dl/g.

4. The method according to claim 1, wherein the recycled polyester is obtained by mechanical recycling, by chemical recycling, enzymatic recycling or pyrolysis recycling.

5. The method according to claim 4, wherein the weight amount of the recycled polyester in the polymer material is between 10% and 90%, the weight amount of the virgin polyester being at least 10% relative to the total weight of the polymer material.

6. The method according to claim 4, wherein the polymer material comprises 100% of recycled polyester.

7. The method according to claim 1, wherein the weight amount of recycled polyester in the polymer material is less than 100%, the polymer material consisting of a mixture of recycled polyester and virgin polyester.

8. The method according to claim 1, wherein the injection-moulded article is devoid of compatibilizing agent between the recycled polyester and the virgin polyester.

9. The method according to claim 1, wherein the recycled polyester comprises less than 20 ppm of particles other than polyester.

10. The method according to claim 1, wherein the polyester is a polyethylene terephthalate.

11. The method according to claim 1, wherein the injection-moulded article is a preform of an aerosol bottle comprising a tubular body closed at one end and a neck.

12. The method according to claim 11, wherein the the polymer material is weakly crystallizable, the process comprising crystallizing a portion of the injection-molded article, wherein the crystallized part is the neck of the preform.

13. A method for manufacturing an aerosol bottle, wherein the bottle is formed by stretch-blow-moulding a preform obtained by the method according to claim 1.

14. An aerosol bottle, obtained from a preform obtained using the method for manufacturing an injection-moulded article according to claim 1.

15. The method of claim 1, wherein the injection-molded article is a preform of an aerosol bottle.
